(19) United States
(12) Patent Application Publication
(10) Pub. No.: US 2007/0058945 A1
(43) Pub. Date: Mar. 15, 2007

(54) Method for archiving information

(76) Inventors: Karen A. Pickner, Ortonville, MI (US); Paul Pickner, Ortonville, MI (US); Luann T. Robinson, Pontiac, MI (US)

Correspondence Address: Richard E. Hoffmann, PO Box 70098, Rochester Hills, MI, 48307, US

(21) Appl. No.: 11/521,972

(22) Filed: Sep. 15, 2006

Related U.S. Application Data
(60) Provisional application No. 60/717,367, filed on Sep. 15, 2005.

(51) Int. Cl. H04N 7/00

(52) U.S. Cl. 386/96

(57) ABSTRACT

A method for archiving information is provided. The method includes the steps of performing an evaluation. The evaluation can comprise any medical, physical, psychological or similar test. The evaluation is recorded by a suitable recording device. The recorded information is then fixed on a suitable storage media for later use. In addition to fixing the recorded information on a storage media, a written report of the evaluation may also be obtained. The written report, or a suitable translation thereof can be also fixed on the storage media.

### CROSS-REFERENCE TO RELATED APPLICATION

This application claims the benefit of U.S. Provisional Application No. 60/717,367 filed Sep. 15, 2005. The disclosure of the above application is incorporated herein by reference.

### TECHNICAL FIELD OF THE INVENTION

The present invention relates to a method of obtaining and archiving information.

### BACKGROUND OF THE INVENTION

In many areas, medical information is needed to be obtained for use in later proceedings. For example, in cases where workers compensation, personal injury, or injuries related to vehicle accidents are alleged, medical, physical and psychological evaluations may need to be conducted of the individual or individuals making the claim. Currently, such evaluation is conducted by appropriately trained personnel. A written report is typically made of the evaluation. This written report is stored and later used in proceedings, such as court proceedings, or any other proceeding used to evaluate the validity of the individual's claim. A primary problem incurred is that the tests are often conducted at a time far removed from when the decision relating to the validity of the claim is made. Typically, prior to the later determination, an independent medical, physical or psychological examination must take place in order to make the proper finding. Further, the evidence typically used at these proceedings to determine the validity consists of the written report of the individuals conducting the tests made earlier to the decision and the testimony of the person who conducted the test earlier, which testimony often is based on the written report.

Accordingly, there is a desire to provide a method for recording the tests as they take place and archiving the results of the tests for later use.

### SUMMARY OF THE INVENTION

According to the present invention, there is provided a method for archiving an evaluation. The method comprises recording the evaluation. The recorded evaluation is fixed on a storage media.

### BRIEF DESCRIPTION OF THE DRAWINGS

The present invention will become more fully understood when considered in connection with the detailed description and the accompanying drawings, wherein:

FIG. 1 is a schematic representation of the method in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

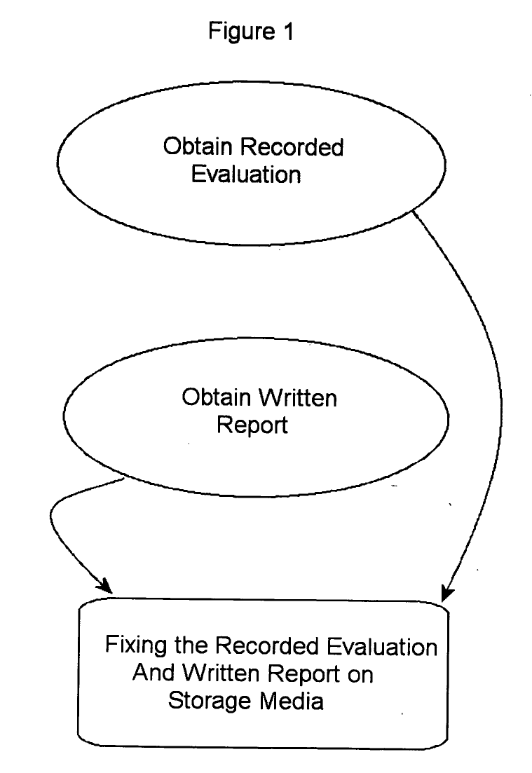

FIG. 1 schematically shows the general steps of the present method. Initially, the method comprises obtaining recorded information pertaining to evaluation. The evaluations can be, but are not limited to, medical, physical or psychological evaluations conducted by a professional. Specifically, an individual is seen by a credentialed health care professional, such as a physician, psychiatrist, psychologist, physical therapist, or the like. The health care professional conducts a series of appropriate tests to complete an evaluation. Any of a number of evaluations can be performed. Such evaluations include, for example, neurological examinations, psychological examinations, physical function evaluations, thermalography evaluations, or any combinations of these evaluations. It will be appreciated that any appropriate evaluation or test may be conducted in accordance with the present invention.

Often times, the evaluation comprises tests required for certain circumstances that are performed pursuant to established protocols. For example, established test protocols are commonly used to evaluate injury claims in no fault vehicle accident cases. The subject invention is particularly useful to record the test requirements.

As the tests are being conducted, they are simultaneously recorded. Preferably the recording is an audio/visual work that may be recorded, for example, using a suitable video recorder. The video recorder may comprise any type of recorder that can record visual images, regardless of the manner of recording. Further, its preferable that the video recorder also be able to record sound. It will be appreciated, however, that any manner of recording the evaluation is contemplated within the scope of the present invention.

The credentialed individual performing the test also typically produces a written report. This written report is also obtained. Preferably, the written report is translated into a storage media such as by scanning into a computer readable file. It will be appreciated, however, that any manner of obtaining the written report is contemplated within the scope of the present invention.

Once the testing and reporting are completed, the recorded evaluation is then transferred to a storage media. The recorded evaluation may be edited, for example, to remove long delays between testing or to add titles. Any editing should not be used for the purpose of altering or modifying the evaluation results. That is, all tests conducted should be contained on the storage media. It is preferred that the written report also be transferred to the storage media. The storage media is preferably a portable storage media that can be easily moved and stored.

It is preferred that the storage media to which both the recorded evaluation and written report are transferred comprise a digital video disc. Both the recorded evaluation and written report can be transferred to the digital video disc through use of a computer in a known manner. A videotaped or recorded evaluation may also need to be converted to a computer readable file prior to being transferred to the storage media.

It will be appreciated, that the storage media can be any suitable storage media, including the hard drive of the computer itself, or any known storage media, such as, for example, but not limited to, floppy disks, tape media, compact discs, a portable drive or other portable storage media.

Once the recorded information and written report have been fixed in a storage media, the information is archived so that it may be used in subsequent proceedings, for example, court or administrative proceedings. This type of archiving may help reduce the need for later independent medical examinations because the examination took place closer in time to the event requiring the evaluation and was recorded and performed by credentialed individuals. Further, the archiving of the examinations can occur well prior in time to when the evaluation of the individual is reviewed for validity. This preserves the actual evaluation results for use at a later time. This type of archiving is particularly useful for attorneys and court personnel to preserve data. It is also beneficial for agencies (such as governmental agencies or insurance companies) to archive particularly when administrative decisions or insurance claims are based on the results of such evaluations.

This type of archiving may also help the health care practitioner who may be called upon to remember details contained in her report at a later proceeding. Specifically, the health care practitioner can have the recorded evaluation available for recollection purposes.

In this manner, the archived copies can be kept by suitable authorities, such as attorneys, or administrative agencies for evaluating and making dispositions on certain disability and/or injury claims.

What is claimed is:

1. A method for archiving an evaluation comprising:
recording the evaluation; and
fixing the recorded evaluation on a storage media.

2. A method as set forth in claim 1 further comprising obtaining a written report pertaining to the evaluation;
translating the written report into a computer recordable file; and
fixing the translated written report on the storage media.

3. A method as set forth in claim 2 wherein the storage media is a digital video disc.

4. A method as set forth in claim 3 wherein the recorded information comprises an audio-visual recording of an evaluation.

5. A method as set forth in claim 4 wherein the evaluation comprises a neurological examination.

6. A method as set forth in claim 4 wherein the evaluation comprises a psychological examination.

7. A method as set forth in claim 4 wherein the evaluation comprises a physical function evaluation.

8. A method as set forth in claim 4 wherein the evaluation comprises a thermalography evaluation.

9. A method as set forth in claim 4 wherein the evaluation comprises combinations of at least two of neurological examination, psychological examination, physical function evaluation or thermalography evaluation.
